(19) United States
(12) Patent Application Publication
(10) Pub. No.: US 2008/0218774 A1
(43) Pub. Date: Sep. 11, 2008

(54) Configurable printer for different locations and methods of configuring a printer for different locations

(75) Inventors: Bart C. Shuldman, Westport, CT (US); Donald E. Brooks, Ithaca, NY (US); Steven P. Hilsdorf, Willseyville, NY (US)

Correspondence Address: Lipsitz & McAllister, LLC, 755 MAIN STREET, MONROE, CT, 06468, US

(73) Assignee: TransAct Technologies Incorporated, Wallingford, CT (US)

(21) Appl. No.: 11/715,069

(22) Filed: Mar. 6, 2007

(51) Int. Cl. G06K 15/00

(52) U.S. Cl. 358/1.2; 358/1.15; 358/1.16; 358/1.6

(57) ABSTRACT

A configurable printer for different locations and methods for configuring a printer for different locations are provided. The printer includes memory loaded with different versions of firmware. Each version of firmware may enable a different printer configuration for a corresponding location. The printer also includes an interface for accepting a signal from a control device. The signal may comprise instructions to the printer to load a particular version of the firmware that corresponds to the location of the control device.

### BACKGROUND OF THE INVENTION

The present invention relates to the field of printing. More specifically, the present invention relates to a configurable printer for different locations and methods for configuring a printer for different locations.

It is typically necessary to customize printers, such as printers used in the gaming industry, a point of sale terminal printer, or other printers so that they print in a language of the location that the printer is used. Further, it may also be necessary to provide a particular print template or print design for a particular location or for a particular type of host device the printer is associated with.

There are several prior art ways in which a printer can be configured for a specific location so that the printer prints text in a desired language of that location or prints a particular style of template or design for an associated host device at that location. For example, the printer may be pre-loaded with firmware which configures the printer to print in a particular language, template style, and/or print design, depending on where the printer was ordered from or being shipped to. Alternately, a generic printer may be provided and specific firmware uploaded to the printer once it reaches its destination. Such a firmware upload may require the presence of an onsite technician to complete the upload once the printer is installed or a connection to a source of a firmware download in order to complete the firmware upload remotely.

With the advent of low cost memory components, an improved approach is possible that allows for simpler ways to configure a printer for different locations. It would be advantageous to improve the ease of implementing different firmware depending on the location of a printer and/or different types of host devices associated with the printer. It would be further advantageous to preload the printer with multiple versions of firmware corresponding to different locations and/or types of host devices. It would also be advantageous to enable a selection of a particular version of the firmware via a signal to the printer indicating a location and/or type of host device. In addition, it would be advantageous if such a signal was provided by a control device at the printer location or by the host device itself.

The methods and apparatus of the present invention provide the foregoing and other advantages.

### SUMMARY OF THE INVENTION

The present invention relates to a configurable printer for different locations and methods for configuring a printer for different locations.

In an example embodiment of the present invention, a configurable printer is provided. The printer includes memory loaded with different versions of firmware. Each version of firmware may enable a different printer configuration for a corresponding location. The printer also includes an interface for accepting a signal from a control device. The signal may comprise instructions to the printer to load a particular version of the firmware which corresponds to the location of the control device.

In one example embodiment, the control device may comprise a host device associated with the printer. For example, the host device may be one of a gaming machine, a computer, a point-of-sale terminal, an automated teller machine, a vending machine, a transportation ticket machine, an entertainment ticket machine, a self-service gasoline pump, or the any other device or machine that includes an integral printer or communicates with a stand-alone printer.

In an alternative example embodiment, the printer may be associated with a host device and the control device may be external to and separate from the host device. In such an example embodiment, the control device may comprise one of a computer, a personal digital assistant, a USB jump drive, a removable memory device, an Internet appliance, a cellular telephone, or the like.

The interface may be a wired interface as is known in the art. Alternatively, the interface may be a wireless interface. The wireless interface may be a wireless communication port adapted to accept any type of wireless signal, such as a wireless local area network signal, a Bluetooth® signal, or the like.

The location may correspond to one of a country, a region, a state, a city, a town, a building, a group of buildings, an area within a building, a floor of a building, a location of a host device associated with the printer, a location of a group of host devices, or any other indicator of a position or location of the control device, a position or location of the host device, or of a position or location of use of the printer.

Each version of firmware may configure the printer for at least one of a particular language, style, template, graphics, paper size, font size, font style, print position, print color, print justification, a number of characters per inch, and the like, each corresponding to the location of the control device.

The memory may store more than one version of firmware for each of the locations, enabling more than one printer configuration for each of the locations. For example, the printer may include two different versions of firmware for Japan, each of which configures the printer to print in Japanese, with each different version providing a different template style.

The different versions of firmware may be loaded into the printer at a time of manufacture of the printer. Alternatively, the different versions of firmware may be loaded into the printer subsequent to a time of manufacture of the printer.

In a further example embodiment, the printer may be associated with a host device. Each of the different versions of firmware may also enable a different printer configuration for a corresponding type of host device. Thus, the signal from the control device comprises instructions to the printer to load a particular version of the firmware which corresponds to the location of the control device and to the type of the host device.

The control device may be either internal to or external to the host device.

The present invention also includes methods of configuring a printer for different locations, which methods correspond to the foregoing printer embodiments. In an example embodiment of such a method, different versions of firmware are stored in printer memory, each version of firmware enabling a different printer configuration for a corresponding location. A signal is provided from a control device to the printer. The signal comprises instructions to the printer to load a particular version of the firmware which corresponds to the location of the control device. Additional details discussed above in connection with the various example printer embodiments are also applicable to the example method embodiments of the present invention.

### BRIEF DESCRIPTION OF THE DRAWINGS

The present invention will hereinafter be described in conjunction with the appended drawing figures, wherein like reference numerals denote like elements, and:

FIG. 1 shows a block diagram of a first example embodiment of a configurable printer in accordance with the present invention; and

FIG. 2 shows a block diagram of a second example embodiment of a configurable printer in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

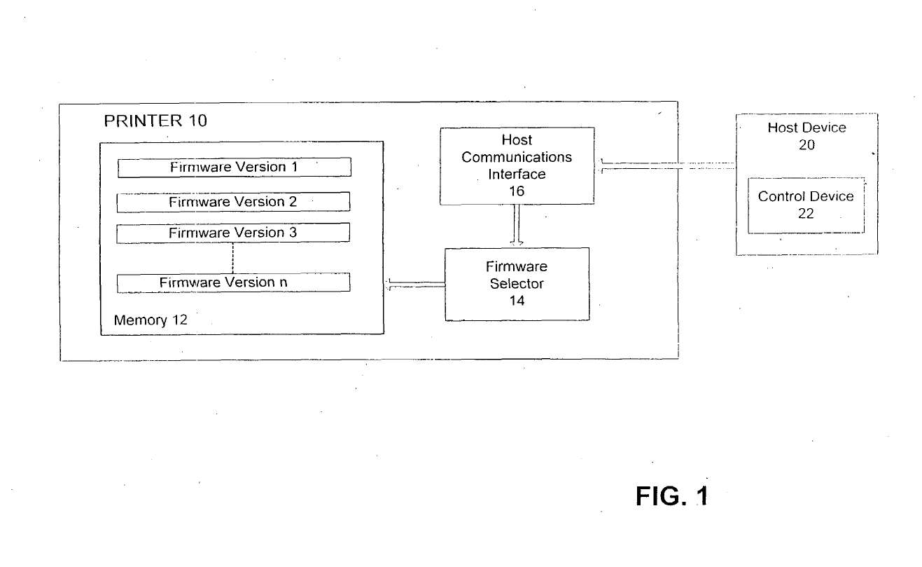

In an example embodiment of the present invention as shown in FIG. 1, a configurable printer 10 is provided. The printer 10 includes memory 12 loaded with different versions of firmware (e.g., firmware version 1, firmware version 2, firmware version 3, and firmware version n). Each version of firmware may enable a different printer configuration for a corresponding location. The printer 10 also includes an interface 16 for accepting a signal from a control device 22. The signal may comprise instructions to the printer 10 to load a particular version of the firmware from memory 12 which corresponds to the location of the control device 22.

In the example embodiment shown in FIG. 1, the control device 22 may comprise a host device 20 associated with the printer 10. The host device 20 may be any type of device that sends print commands to a printer, including any device that has an integral printer and any device that is hooked up to a printer (via either a wired or wireless connection). For example, the host device 20 may be one of a gaming machine, a computer, a point-of-sale terminal, an automated teller machine, a vending machine, a transportation ticket machine, an entertainment ticket machine, a self-service gasoline pump, or the any other device or machine that includes an integral printer or communicates with a stand-alone printer.

In the embodiment shown in FIG. 1, the signal may be communicated to interface 16 directly from the control device 22 or from the host device 20 containing the control device 22. Those skilled in the art should appreciate that the control device 22 may comprise software instructions contained in the host device 20, a separate processing device, or any combination of hardware, software, and/or firmware contained in the host device 20. The signal may be received at interface 16 and forwarded to a firmware selector 14, which directs the printer 10 to load the appropriate firmware from memory 12 for the location of the control device 22. The selected version of firmware may be loaded into the printer 10 by a boot program run by a processor (not shown) at printer startup as is known in the art. The host device 20 may also communicate printer commands to the interface 16, which printer commands may be executed via the printer processor (not shown) as is known in the art.

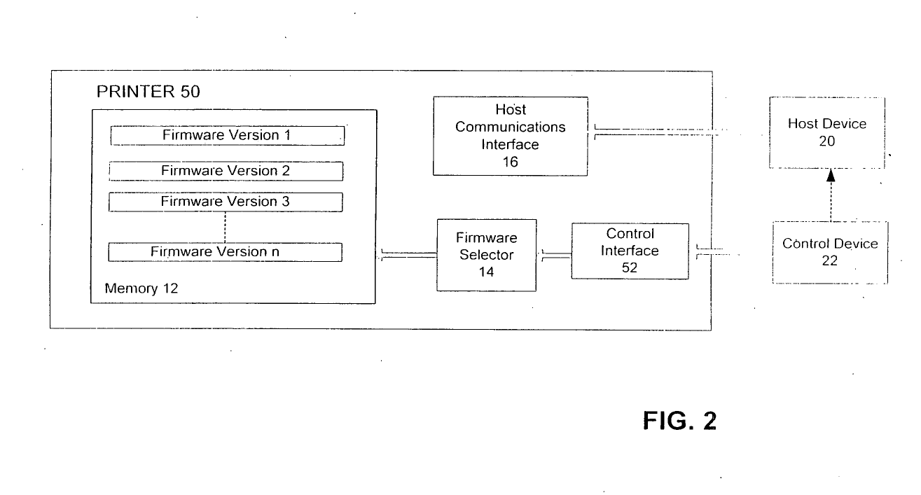

In an alternate example embodiment of the present invention as shown in FIG. 2, the printer 50 may be associated with a host device 20 and the control device 22 may be external to and separate from the host device 20. The host device 20 may communicate printer commands to host communications interface 16, which may be executed at a processor (not shown) of the printer, as is known in the art.

In such an example embodiment, the control device 22 may comprise one of a computer, a personal digital assistant, a USB jump drive, a removable memory device, an Internet appliance, a cellular telephone, or the like. The control device 22 may communicate with the printer 50 via a control interface 52. The control interface 52 may communicate the signal to the firmware selector 14, which then selects the appropriate firmware version to load from memory 12, as discussed above in connection with FIG. 1.

FIG. 2 shows the control device 22 external to the host device 20 and communicating the signal directly to the control interface 52 of the printer. Those skilled in the art should appreciate that even when the control device 22 is external to the host device 20, the signal may be first communicated to the host device 20 and then passed on to the host communications interface 16 by the host device 20 (as shown by the optional dashed communication line between the control device 22 and the host device 20 in FIG. 2). The interface 16 would then communicate with the firmware selector 14 as shown in FIG. 1. Such a configuration would eliminate the need for the separate control interface 52 when the control device 22 is external to the host device 20.

The interface host communications interface 16 and/or the control interface 52 may be a wired interface as is known in the art. Alternatively, the interfaces 16 and 52 may each be wireless interfaces. The wireless interface may be a wireless communication port adapted to accept any type of wireless signal, such as a wireless local area network signal, a Bluetooth® signal, or the like.

The location may correspond to one of a country, a region, a state, a city, a town, a building, a group of buildings, an area within a building, a floor of a building, a location of a host device associated with the printer, a location of a group of host devices, or any other indicator of a position or location of the control device, a position or location of the host device, or of a position or location of use of the printer.

Each version of firmware may configure the printer 10, 50 for at least one of a particular language, style, template, graphics, paper size, font size, font style, print position, print color, print justification, a number of characters per inch, and the like, each corresponding to the location of the control device 22 or the location of the host device 20. In most instances, the host device 20 and the control device 22 will be co-located, even when the control device 22 is external to the host device 20. However, those skilled in the art will appreciate that the control device 22 may be located remote from the host device 20, and communicate with either the host device 20 or the printer 50 via a wired or wireless connection (or a combination thereof). For example, the control device 22 may be centrally located in a central office of a company that owns or operates many printers in different buildings, states, countries, or continents. In such instances, the remotely located control device may signal each printer (e.g., via an Internet connection of a Wide Area Network) to select and load a version of firmware corresponding to the location of the host device 20, rather than that of the remotely located control device 22.

The memory 12 may store more than one version of firmware for each of the locations, enabling more than one printer configuration for each of the locations. For example, the printer may include two different versions of firmware for Japan, firmware version 2 and firmware version 3. Firmware version 2 may configure the printer 10, 50 to print in one Japanese dialect with a first template style. Firmware version 3 may configure the printer 10, 50 to print in a different Japanese dialect with a second template style.

The different versions of firmware may be loaded into the printer memory 12 at a time of manufacture of the printer 10, 50. Alternatively, the different versions of firmware may be loaded into the printer memory 12 subsequent to a time of manufacture of the printer 10, 50.

As shown in FIGS. 1 and 2, the printer 10, 50 may be associated with a host device 20. Each of the different versions of firmware in memory 12 (e.g., firmware version 1, firmware version 2, firmware version 3, . . . , and firmware version n) may also enable a different printer configuration for a corresponding type of host device 20. Thus, the signal from the control device 22 may comprise instructions to the printer 10, 50 to load a particular version of the firmware which corresponds to both the location of the control device 22 and the type of the host device 20. For example, the signal may indicate that the host device 20 is a gaming machine and has an associated control device 22 located in Japan. Thus, appropriate firmware for a gaming machine printer in Japan will be selected from the different versions of firmware stored in the printer memory 12 and loaded into the printer, thereby configuring the printer for use with a gaming machine located in Japan (e.g., enabling the printer to print in Japanese and/or with a particular template style and/or graphics, etc. for a gaming machine).

The present invention simplifies the process of customizing a printer for a particular location and/or host device which sends print commands to a printer. By loading different versions of firmware into printer memory, the appropriate version of firmware may simply be selected from printer memory and loaded into the printer upon receipt of a signal from a control device (which may be separate from the host device or part of the host device which is associated with the printer). This process may occur automatically, for example, when the printer is initially installed in or connected to a host device or when the control device is connected to the printer. Alternatively, this process may be initiated after the printer is installed in or connected to the host device or connected to the control device (e.g., via a switch or other user interface on the host device or control device).

It should now be appreciated that the present invention provides advantageous methods and apparatus for configuring a printer for different locations.

Although the invention has been described in connection with various illustrated embodiments, numerous modifications and adaptations may be made thereto without departing from the spirit and scope of the invention as set forth in the claims.

What is claimed is:

1. A configurable printer for different locations, comprising:
memory having different versions of firmware, each version of firmware enabling a different printer configuration for a corresponding location; and
an interface for accepting a signal from a control device, said signal comprising instructions to said printer to load a particular version of said firmware which corresponds to the location of said control device.

2. A configurable printer in accordance with claim 1, wherein:
said control device comprises a host device associated with said printer.

3. A configurable printer in accordance with claim 2, wherein:
said host device comprises one of a gaming machine, a computer, a point-of-sale terminal, an automated teller machine, a vending machine, a transportation ticket machine, an entertainment ticket machine, and a self-service gasoline pump.

4. A configurable printer in accordance with claim 1, wherein:
said printer is associated with a host device; and
said control device is external to said host device.

5. A configurable printer in accordance with claim 4, wherein:
said control device comprises one of a computer, a personal digital assistant, a USB jump drive, a removable memory device, an Internet appliance, and a cellular telephone.

6. A configurable printer in accordance with claim 1, wherein:
said interface is one of a wired interface or a wireless interface.

7. A configurable printer in accordance with claim 1, wherein:
said location comprises one of a country, a region, a state, a city, a town, a building, a group of buildings, an area within a building, a floor of a building, a location of a host device associated with said printer, or a location of a group of said host devices.

8. A configurable printer in accordance with claim 1, wherein:
each version of firmware configures said printer for at least one of a particular language, style, template, graphics, paper size, font size, font style, print position, print color, print justification, and a number of characters per inch, corresponding to said location of said control device.

9. A configurable printer in accordance with claim 1, wherein:
said memory stores more than one version of firmware for each of said locations, enabling more than one printer configuration for each of said locations.

10. A configurable printer in accordance with claim 1, wherein:
said different versions of firmware are loaded into said printer at a time of manufacture of said printer.

11. A configurable printer in accordance with claim 1, wherein:
said different versions of firmware are loaded into said printer subsequent to a time of manufacture of said printer.

12. A configurable printer in accordance with claim 1, wherein:
said printer is associated with a host device;
each of said different versions of firmware further enables said different printer configuration for a corresponding type of host device; and
said signal from said control device comprises instructions to said printer to load a particular version of said firmware which corresponds to the location of said control device and a type of said host device.

13. A configurable printer in accordance with claim 12, wherein:
said host device comprises one of a gaming machine, a computer, a point-of-sale terminal, an automated teller machine, a vending machine, a transportation ticket machine, an entertainment ticket machine, and a self-service gasoline pump.

14. A configurable printer in accordance with claim 12, wherein:
each version of firmware configures said printer for at least one of a particular language, style, template, graphics, paper size, font size, font style, print position, print color, print justification, and a number of characters per inch, corresponding to said location and type of said host device.

15. A configurable printer in accordance with claim 12, wherein:
said control device is internal to said host device.

16. A configurable printer in accordance with claim 12, wherein:
said control device is external to said host device.

17. A method of configuring a printer for different locations, comprising:
storing different versions of firmware in printer memory, each version of firmware enabling a different printer configuration for a corresponding location; and
providing a signal from a control device to said printer, said signal comprising instructions to said printer to load a particular version of said firmware which corresponds to the location of said control device.

18. A method in accordance with claim 17, wherein:
said control device comprises a host device associated with said printer.

19. A method in accordance with claim 18, wherein:
said host device comprises one of a gaming machine, a computer, a point-of-sale terminal, an automated teller machine, a vending machine, a transportation ticket machine, an entertainment ticket machine, and a self-service gasoline pump.

20. A method in accordance with claim 17, wherein:
said printer is associated with a host device; and
said control device is external to said host device.

21. A method in accordance with claim 20, wherein:
said control device comprises one of a computer, a personal digital assistant, a USB jump drive, a removable memory device, an Internet appliance, and a cellular telephone.

22. A method in accordance with claim 20, wherein:
a printer interface is adapted to accept said signal from said control device; and
said interface is one of a wired interface or a wireless interface.

23. A method in accordance with claim 17, wherein:
said location comprises one of a country, a region, a state, a city, a town, a building, a group of buildings, an area within a building, a floor of a building, a location of a host device associated with said printer, or a location of a group of said host devices.

24. A method in accordance with claim 17, wherein:
each version of firmware configures said printer for at least one of a particular language, style, template, graphics, paper size, font size, font style, print position, print color, print justification, and a number of characters per inch, corresponding to said location of said control device.

25. A method in accordance with claim 17, wherein:
more than one version of firmware for each of said locations is stored in said memory, enabling more than one printer configuration for each of said locations.

26. A method in accordance with claim 17, wherein:
said different versions of firmware are loaded into said printer memory at a time of manufacture of said printer.

27. A method in accordance with claim 17, wherein:
said different versions of firmware are loaded into said printer memory subsequent to a time of manufacture of said printer.

28. A method in accordance with claim 17, wherein: said printer is associated with a host device;
each of said different versions of firmware further enables said different printer configuration for a corresponding type of host device; and
said signal from said control device comprises instructions to said printer to load a particular version of said firmware which corresponds to the location of said control device and a type of said host device.

29. A method in accordance with claim 28, wherein:
said host device comprises one of a gaming machine, a computer, a point-of-sale terminal, an automated teller machine, a vending machine, a transportation ticket machine, an entertainment ticket machine, and a self-service gasoline pump.

30. A method in accordance with claim 28, wherein:
each version of firmware configures said printer for at least one of a particular language, style, template, graphics, paper size, font size, font style, print position, print color, print justification, and a number of characters per inch, corresponding to said location and type of said host device.

31. A method in accordance with claim 28, wherein:
said control device is internal to said host device.

32. A method in accordance with claim 28, wherein:
said control device is external to said host device.
